(19) United States
(12) Patent Application Publication
(10) Pub. No.: US 2023/0035362 A1
(43) Pub. Date: Feb. 2, 2023

(54) Use of Trivalent Doped Cerium Oxide Compositions for Biological Contaminant Removal

(71) Applicant: Neo Chemicals & Oxides, LLC, Greenwood Village, CO (US)

(72) Inventors: Dimitrios Psaras, Bound Brook, NJ (US); Mason Reames Haneline, Orange, CA (US); Steven P. Williams, London (GB)

(73) Assignee: Neo Chemicals & Oxides, LLC, Greenwood Village, CO (US)

(21) Appl. No.: 17/870,068

(22) Filed: Jul. 21, 2022

Related U.S. Application Data
(60) Provisional application No. 63/224,317, filed on Jul. 21, 2021.

(51) Int. Cl. C01F 17/235; B01J 20/06; C02F 1/28

(52) U.S. Cl. CPC C01F 17/235; B01J 20/06; C02F 1/281

(57) ABSTRACT

A trivalent doped cerium oxide composition is beneficial to aid in the removal of biological contaminants, such as bacteria, viruses, fungi, protozoa (e.g., amoebae), yeast and algae. These trivalent doped cerium oxide compositions can be used to remove these biological contaminants from fluids, including air and water, and from solid surfaces. The compositions also include a support material. Also described are methods of using compositions containing these trivalent doped cerium oxide compositions to remove biological contaminants.

### RELATED APPLICATION

This application claims priority to and benefit of U.S. Provisional Application No. 63/224,317 filed Jul. 21, 2021, the contents of which are hereby incorporated by reference in their entirety.

### FIELD OF THE INVENTION

This disclosure relates to the use of trivalent doped cerium oxide (CeO₂) compositions for biological contaminant removal. These compositions can be used as antimicrobial/antibacterial/antiviral agents. As such, these compositions have uses for removing bacteria, viruses, protozoa (e.g., amoebae), fungi (e.g., mold), algae, yeast, and the like. In particular, these compositions can be used in methods for treating fluids, including liquids or air, and solid surfaces through contact.

### INTRODUCTION

This disclosure relates generally to trivalent doped CeO₂ compositions for removing bacteria, viruses, and other microbial contaminants through contact. As such, compositions containing these trivalent doped CeO₂ species can remove biological contaminants from air and aqueous liquid streams and can particularly remove bacteria and viruses from air and water whether the microbes are in high or very low concentrations. These trivalent doped cerium oxide have unique structural and electrochemical properties that make them useful for these important purposes.

Various technologies have been used to remove biological contaminants from air and aqueous systems. Examples of such techniques include adsorption on high surface area materials, such as alumina, filters with pore sizes smaller than the biological contaminants, and the use of highly oxidative materials such as chlorine and bromine. Certain metals have also found use because they exhibit the oligodynamic effect which is the biocidal effect of metals. Metals known to exhibit the oligodynamic effect are Al, Sb, As, Ba, Si, B, Cu, Au, Pb, Hg, Ni, Ag, Th, Sn, and Zn. Incorporation of these into technologies for air or aqueous system treatment remains a challenge as the toxicity towards human and animal life and the cost are major concerns.

The need for effective and inexpensive antimicrobial materials to remove bacteria, viruses, and other microbial contaminants, from fluids, including air, water, and other aqueous systems, remains.

### SUMMARY

This disclosure relates generally to trivalent doped cerium oxide compositions for removing biological contaminants. The compositions comprise a support material and a trivalent doped cerium oxide. The composition has biological contaminant removal properties, and as such, has uses for removing bacteria or viruses from fluids, including air and water, and/or from surfaces. The biological contaminants to be removed include bacteria, viruses, protozoa (e.g., amoebae), fungi (e.g., mold or fungus), and the like.

The compositions for removing biological contaminants as disclosed herein comprises a support material comprising an organic polymer, cotton, glass fiber, or mixture thereof; and a trivalent doped cerium oxide composition comprising a cerium oxide doped with a trivalent dopant selected from the group consisting of yttrium (Y), lanthanum (La), neodymium (Nd), praseodymium (Pr), and mixtures thereof, wherein the trivalent doped cerium oxide composition is deposited on or within the support material. In certain embodiments, the trivalent doped cerium oxide composition consists of the cerium oxide doped with the trivalent dopant selected from the group consisting of yttrium (Y), lanthanum (La), neodymium (Nd), praseodymium (Pr), and mixtures thereof.

In specific embodiments, these compositions comprise about 0.5 to about 80 weight % trivalent doped cerium oxide composition based on the total weight of the composition.

The composition containing the support material and trivalent doped cerium oxide is in a rigid or elastic form and this composition can be made into an article for removing biological contaminants, such as a filter, a fixed bed filter system, a plastic or glass bottle or container, a plastic or glass touch surface, and the like.

In one embodiment, a plastic article is disclosed. This plastic article comprises: a composition for removing biological contaminants comprising (i) an organic polymer selected from the group consisting of polyethylene, polyvinyl chloride, nylon, polypropylene, polyester, polyurethane, polyamide, polyolefin, polycarbonate, copolymers thereof, and mixtures thereof; and (ii) a trivalent doped cerium oxide composition comprising a cerium oxide doped with a trivalent dopant selected from the group consisting of yttrium (Y), lanthanum (La), neodymium (Nd), praseodymium (Pr), and mixtures thereof, wherein the trivalent doped cerium oxide composition is deposited on or within the organic polymer; and wherein the plastic article comprises about 50 to about 100 weight percent of the composition for removing biological contaminants based on the total weight of the plastic article. The plastic article can be a filter, a fixed bed filter system, a plastic bottle or container, a plastic touch surface, a plastic doorknob or handle cover, a plastic elevator button cover, and the like.

The compositions for removing biological contaminants as disclosed herein also can be used in methods for removing biological contaminants. These biological contaminants include bacteria, viruses, protozoa (e.g., amoebae), fungi (e.g., mold or fungus), and the like.

In one embodiment the method for removing biological contaminants upon contact comprises: (i) providing a composition comprising a support material comprising an organic polymer, cotton, glass fiber or mixture thereof and a trivalent doped cerium oxide composition comprising a cerium oxide doped with a trivalent dopant selected from the group consisting of yttrium (Y), lanthanum (La), neodymium (Nd), praseodymium (Pr), and mixtures thereof; (ii) contacting the composition with a biological contaminant wherein the biological contaminant is selected from the group consisting of bacteria, viruses, fungi, protozoa (e.g., amoebae), and mixtures thereof; and (iii) removing at least about 90% of the biological contaminant through contact with the composition. In some embodiments, the composition can be a filter material or a plastic.

In certain embodiments the methods treat an aqueous stream and the biological contaminant is in the aqueous stream. In other embodiments, the methods treat a gaseous stream and the biological contaminant is in the gaseous stream. In yet other embodiments, the contacting is through touch of a solid to the composition and thus treat a solid surface through touch.

In specific embodiments of treating a gaseous or aqueous stream, the methods may further comprise a step of setting a target concentration of biological contaminant. In these embodiments, a biological contaminant may be identified and a target concentration for that biological contaminant may be set. The methods additionally may comprise a step of monitoring the treated stream for the biological contaminant.

In specific embodiments of the methods, these methods are for removing biological contaminants from fluid or are methods for treating a fluid. In these embodiments, the fluid may be a gaseous or aqueous stream. In these embodiments, the methods comprise (i) providing a composition comprising a support material comprising an organic polymer, cotton, glass fiber, or mixture thereof and a trivalent doped cerium oxide composition comprising a cerium oxide doped with a trivalent dopant selected from the group consisting of yttrium (Y), lanthanum (La), neodymium (Nd), praseodymium (Pr), and mixtures thereof; (ii) contacting a biological contaminant containing gaseous or aqueous stream with the composition, wherein the biological contaminant is selected from the group consisting of bacteria, viruses, fungi, protozoa (e.g., amoebae), and mixtures thereof; and (iii) removing biological contaminant from the gaseous or aqueous stream through contact with the composition. The biological contaminant can be removed in an amount of 90% or more.

In other embodiments for removing biological contaminants from fluid (e.g., a gaseous or aqueous stream), the methods comprise (i) providing a composition comprising a support material comprising an organic polymer, cotton, glass fiber, or mixture thereof and a trivalent doped cerium oxide composition comprising a cerium oxide doped with a trivalent dopant selected from the group consisting of yttrium (Y), lanthanum (La), neodymium (Nd), praseodymium (Pr), and mixtures thereof; (ii) contacting a biological contaminant containing gaseous or aqueous stream with the composition, wherein the biological contaminant is selected from the group consisting of bacteria, viruses, fungi (e.g., mold), protozoa (e.g., amoebae), and mixtures thereof; and (iii) removing biological contaminant from the gaseous or aqueous stream through contact with the composition. The biological contaminant can be removed in an amount of 90% or more. These methods may further comprise monitoring for the biological contaminant after contacting. The monitoring may be done by sampling or may be continuous.

These methods of treating a gaseous or aqueous stream may further comprise a step of setting a target concentration of biological contaminant. In these methods a biological contaminant of interest is identified and then a target concentration for that biological contaminant is set. The methods additionally may comprise a step of monitoring the biological contaminant in the treated stream. The monitoring may be done by sampling or may be continuous.

In specific embodiments, the methods comprise the steps of (i) providing a composition comprising a support material comprising an organic polymer, cotton, glass fiber, or mixture thereof and a trivalent doped cerium oxide composition comprising a cerium oxide doped with a trivalent dopant selected from the group consisting of yttrium (Y), lanthanum (La), neodymium (Nd), praseodymium (Pr), and mixtures thereof; (ii) setting a target concentration of a biological contaminant; (iii) contacting a gaseous or aqueous stream with the composition, and removing biological contaminant through contact with the composition to provide a treated stream; and (iv) monitoring the treated stream for the biological contaminant, wherein the biological contaminant is selected from the group consisting of bacteria, viruses, fungi (e.g., mold), protozoa (e.g., amoebae), and mixtures thereof. The target concentration can be set at a certain amount of contaminant (e.g., virus, bacteria, protozoa/amoebae, or fungi) or can be set at the limit of detection.

### BRIEF DESCRIPTION OF THE FIGURES

FIG. 1 is an SEM image of the composition of Example 1 with a scale bar of 200 nm.

FIG. 2 is an SEM image of the composition of Example 1 with a scale bar of 10 μm.

FIG. 3A is a TEM image of the composition of Example 1 with a scale bar of 100 nm.

FIG. 3B is a TEM image of the composition of Example 1 with a scale bar of 20 nm.

FIG. 3C is a TEM image of the composition of Example 1 with a scale bar of 5 nm.

FIG. 3D is a darkfield TEM image of the composition of Example 1 with a scale bar of 5 nm.

FIG. 4 is an SEM image of the composition of Example 2 with a scale bar of 200 nm.

FIG. 5 is an SEM image of the composition of Example 2 with a scale bar of 20 μm.

FIG. 6A is a TEM image of the composition of Example 2 with a scale bar of 200 nm. The box indicates the zoom area presented in FIG. 6B.

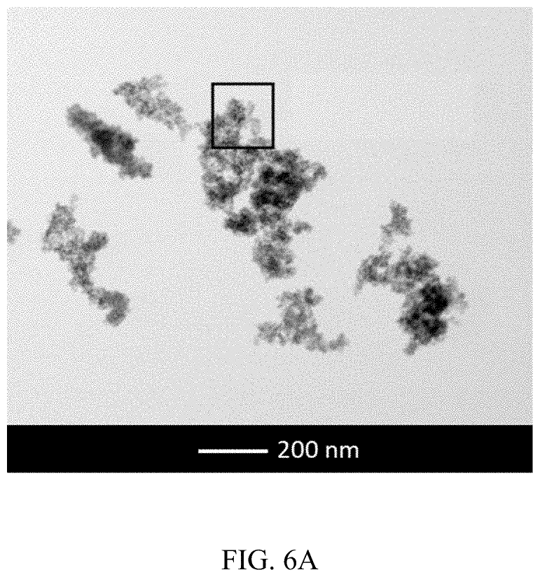

FIG. 6B is a TEM image of the composition of Example 2 with a scale bar of 20 nm. The box indicates the zoom area presented in FIG. 6C and FIG. 6D.

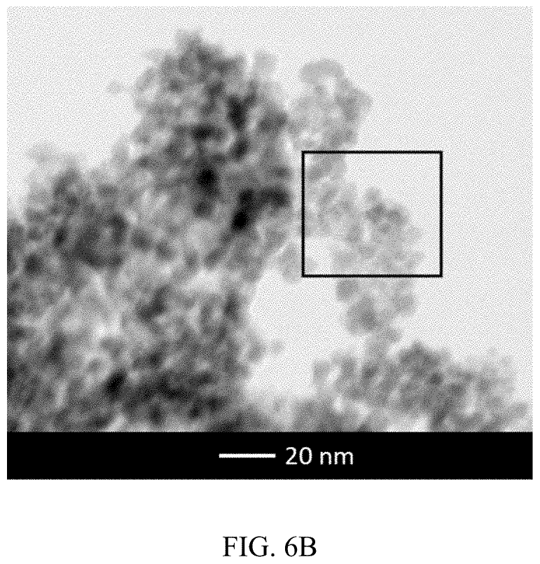

FIG. 6C is a TEM image of the composition of Example 2 with a scale bar of 5 nm.

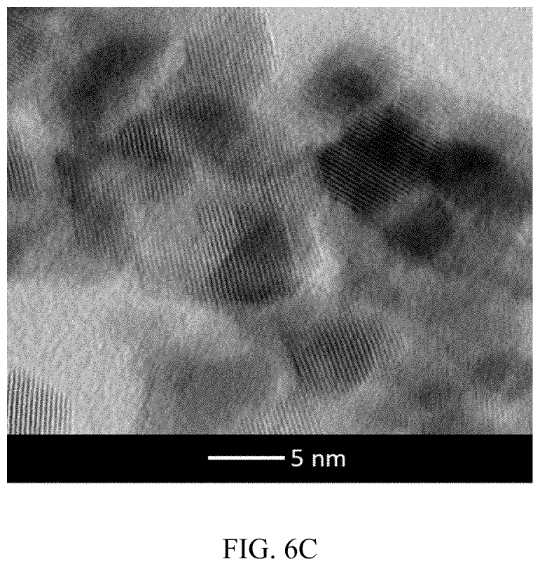

FIG. 6D is a darkfield TEM image of the composition of Example 2 with a scale bar of 5 nm.

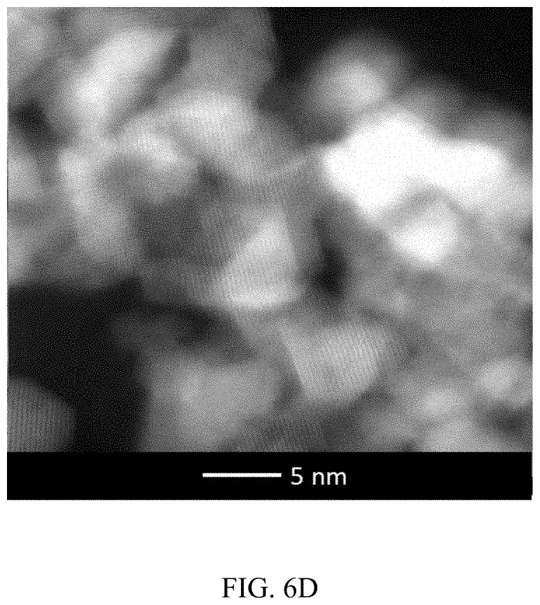

### DETAILED DESCRIPTION

Before the compositions, articles, and methods are disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting. It must be noted that, as used in this specification, the singular forms “a,” “an,” and “the” include plural referents unless the context clearly dictates otherwise. Thus, for example, reference to “a trivalent dopant” is not to be taken as quantitatively or source limiting, reference to “a step” may include multiple steps, reference to “producing” or “products” of a reaction or treatment should not be taken to be all of the products of a reaction/treatment, and reference to “treating” may include reference to one or more of such treatment steps. As such, the step of treating can include multiple or repeated treatment of similar materials/streams to produce identified treatment products.

Singular forms of the biological contaminants also include plural referents. For example, “amoeba” and “virus” include reference to “amoebae” and “viruses”, respectively.

Numerical values with “about” or “approximately” include typical experimental variances. As used herein, the term “about” and “approximately” mean within a statistically meaningful range of a value, such as a stated particle size, concentration range, time frame, molecular weight, temperature, or pH. Such a range can be within an order of magnitude, typically within 10%, and even more typically within 5% of the indicated value or range. Sometimes, such a range can be within the experimental error typical of standard methods used for the measurement and/or determination of a given value or range. The allowable variation encompassed by the term “about” will depend upon the particular system under study, and can be readily appreciated by one of ordinary skill in the art. Whenever a range is recited within this application, every whole number integer within the range is also contemplated as an embodiment of the invention.

The present disclosure relates to trivalent doped CeO₂ compositions having activity for removing biological contaminants and to their use for biological contaminant removal. As such, the trivalent doped CeO₂ compositions disclosed herein are used in compositions and/or articles that are intended to remove biological contaminants and in methods for removing biological contaminants. These biological contaminants include bacteria, viruses, fungi, protozoa (e.g., amoebae), yeast, and mixtures thereof.

The compositions containing trivalent doped cerium oxides (CeO₂) as disclosed herein remove biological contaminants. These compositions comprise a support material and trivalent doped CeO₂. The trivalent doped CeO₂ is deposited on or within the support material.

The trivalent doped CeO₂ is cerium oxide doped with one or more trivalent rare earths. The Ce of the cerium oxide is Ce(IV). The trivalent rare earth dopants can be selected from the group consisting of yttrium (Y), lanthanum (La), neodymium (Nd), praseodymium (Pr), samarium (Sm), europium (Eu), gadolinium (Gd), terbium (Tb), dysprosium (Dy), holmium (Ho), erbium (Er), thulium (Tm), ytterbium (Yb), lutetium (Lu), cerium (Ce), and mixtures thereof. In certain embodiments, the trivalent dopant is yttrium (Y), lanthanum (La), neodymium (Nd), praseodymium (Pr), and mixtures thereof, and in particular embodiments, the trivalent dopant is Nd, La, or a mixture thereof.

The support material comprises an organic polymer, cotton, glass fiber, or mixture thereof. The organic polymer can be a homopolymer of organic monomers or a co-polymer. The organic polymer also can be a thermoset polymer, such as a thermoplastic elastomer. As used herein, the organic polymer is selected from the group consisting of polyethylene, polycarbonate, polyvinyl chloride, nylon, polypropylene, polyester, polyurethane, polyamide, polyolefin, copolymers thereof, and mixtures thereof.

In the compositions as disclosed herein, the trivalent doped cerium oxide composition is deposited on or within the support material. As such, the compositions contain approximately 0.5 to 80 weight % trivalent doped cerium oxide based on the total weight of the composition. In certain embodiments, the compositions contain approximately 0.5 to 50 weight % trivalent doped cerium oxide based on the total weight of the composition. In other embodiments, the compositions contain approximately 0.5 to 25 weight % trivalent doped cerium oxide based on the total weight of the composition. In yet other embodiments, the compositions contain approximately 0.5 to 10 weight % trivalent doped cerium oxide based on the total weight of the composition. In additional embodiments, the compositions contain approximately 0.5 to 5 weight % trivalent doped cerium oxide based on the total weight of the composition.

The composition containing the support material and trivalent doped cerium oxide can be in a rigid or elastic form. The composition can form an article for removing biological contaminants, such as a filter or a plastic container. The article can be in a rigid or elastic form.

In some embodiments, the support material can be an organic polymer. In certain of these embodiments, the trivalent dopant is Nd, La, or a mixture thereof. When this composition using an organic polymer as the support material forms an article, the article can be a plastic article. In these embodiments, the organic polymer can be selected from the group consisting of polyethylene, polyvinyl chloride (PVC), nylon, polypropylene, polyester, polyurethane, polyamide, polyolefin, polycarbonate, copolymers thereof, and mixtures thereof. In specific embodiments, the organic polymer is polyethylene, polycarbonate, or mixtures thereof. When a plastic, the article can be in the form of a filter, bottle, container, or a plastic covering for a high touch service. The filter can be a fixed bed. The bottle or container may be for liquids. High touch surfaces include escalator or stair handrail covering, an elevator button covering, a door, a door handle or knob or covering therefore, coverings on public transportation, touch pads for electronic transactions, and the like.

In some embodiments, the support material can be cotton. In certain of these embodiments, the trivalent dopant is Nd, La, or a mixture thereof. When this composition using cotton as the support material forms an article, the article can be a filter or a fabric.

In some embodiments, the support material can be glass fiber. In certain of these embodiments, the trivalent dopant is Nd, La, or a mixture thereof. When this composition using glass fiber as the support material forms an article, the article can be a filter, bottle, container, or high touch surface. The filter can be a fixed bed. High touch surfaces include an elevator button covering, a door, coverings on public transportation, touch pads for electronic transactions, and the like.

In certain embodiments, the support material can be cotton and an organic polymer. In certain of these embodiments, the organic polymer can be selected from the group consisting of nylon, polyester, polyamide, and mixtures thereof. In certain of these embodiments, the trivalent dopant is Nd, La, or a mixture thereof. When this mixture as the support material forms an article, the article can be a filter or a fabric.

In certain embodiments, the support material can be glass fiber and an organic polymer. The organic polymer can be selected from the group consisting of polyethylene, polyvinyl chloride (PVC), nylon, polypropylene, polyester, polyurethane, polyamide, polyolefin, polycarbonate, copolymers thereof, and mixtures thereof. In certain of these embodiments, the organic polymer can be selected from the group consisting of polyethylene, polycarbonate, and mixtures thereof. In certain of these embodiments, the trivalent dopant is Nd, La, or a mixture thereof. When this mixture as the support material forms an article, the article can be a filter, bottle, container, or high touch surface. The filter can be a fixed bed. High touch surfaces include escalator or stair handrail covering, an elevator button covering, a door, a door handle or knob covering, coverings on public transportation, touch pads for electronic transactions, and the like.

In some embodiments, the support material can be polyethylene or polycarbonate. In certain of these embodiments, the trivalent dopant is Nd, La, or a mixture thereof. And when the composition forms an article, the article can be a plastic article and can be in the form of a filter, bottle, container, or plastic covering for a high touch surface. The filter can be a fixed bed.

In a specific embodiment, the article is a plastic article. The plastic article can be in the form of a filter, bottle, container, or plastic covering for a high touch surface. The plastic article comprises a composition for removing biological contaminants comprising (i) an organic polymer selected from the group consisting of polyethylene, polyvinyl chloride, nylon, polypropylene, polyester, polyurethane, polyamide, polyolefin, polycarbonate, copolymers thereof, and mixtures thereof; and (ii) a trivalent doped cerium oxide composition comprising a cerium oxide doped with a trivalent dopant selected from the group consisting of yttrium (Y), lanthanum (La), neodymium (Nd), praseodymium (Pr), and mixtures thereof, wherein the trivalent doped cerium oxide composition is deposited on or within the organic polymer; wherein the plastic article comprises about 50 to about 100 weight percent of the composition for removing biological contaminants based on the total weight of the plastic article. In certain of these embodiments, the trivalent dopant is Nd, La, or a mixture thereof. In certain of these embodiments, the organic polymer can be selected from the group consisting of polyethylene, polycarbonate, and mixtures thereof.

When the composition forms an article, the article contains about 50 to about 100 weight % of the composition containing the support material and the trivalent doped cerium oxide based on the total weight of the article. In certain embodiments, the article contains about 75 to about 95 weight % of the composition containing the support material and the trivalent doped cerium oxide based on the total weight of the article.

When the trivalent doped cerium oxide and support are formed into an elastic or rigid article, the article also may include binder, sand, gravel, glass wool, a metal or plastic container, and the like.

The compositions and articles as disclosed herein are capable of removing approximately 90% or more of the biological contaminants. In certain embodiments, the compositions and articles as disclosed herein are capable of removing approximately 99% or more of the biological contaminants.

The biological contaminants to be removed by the articles, compositions, and methods disclosed herein include viruses, bacteria, fungi, (e.g., mold or fungus), protozoa (e.g., amoebae), algae, yeast, and the like, and mixtures thereof. In certain embodiments, the biological contaminants to be removed by the articles, compositions, and methods disclosed herein are selected from the group consisting of a bacteria, viruses, fungi (e.g., mold), protozoa (e.g., amoebae), and mixtures thereof. In specific embodiments, the biological contaminants to be removed by the articles, compositions, and methods disclosed herein are bacteria, viruses, amoebae, and mixtures thereof. In other embodiments, the biological contaminants are bacteria, viruses, and mixtures thereof.

In certain embodiments the biological contaminants to be removed include those of concern in aqueous streams, such as wastewater, and those of concern which are air borne.

The bacteria include gram positive and gram negative bacteria. The bacteria include those commonly found in water, including fecal coliform bacteria. The bacteria include, for example, Streptococcus, Staphylococcus, Escherichia coli, Methicillin-resistant Staphylococcus aureus (MRSA), Legionella Pneumophila, Campylobacter Jejuni, Salmonella, Mycobacterium tuberculosis, Corynebacterium diphtheriae, Listeria monocytogenes, Bordetella pertussis, and the like. The viruses include, for example, rhinovirus, coronaviruses, vaccinia, poliovirus, varicella zoster virus, paramyxovirus, influenza virus, morbillivirus, hepatitis A virus (HAV), adenovirus (HAdV), rotavirus (RoV), sapovirus, respiratory syncytial virus (RSV), paramyxovirus, and other enteric viruses, such as noroviruses (NoV), coxsackievirus, echovirus, reovirus and astrovirus, and the like. Other microbial contaminants include protozoa (such as Cryptosporidium) and specifically amoebae (such as Naegleria fowleri). Further microbial contaminants, which are fungi, include Trichophyton mentagrophytes and Aspergillus.

The articles, compositions, and methods disclosed herein, including the cerium oxide doped with trivalent rare earths, reduce the concentration or amount of these biological contaminants.

### Method of Making The Trivalent Doped Cerium Oxide Composition

The trivalent doped cerium oxide compositions, which are capable of reducing the concentration of biological contaminants, are made by the process as disclosed herein.

The cerium oxide doped with trivalent rare earths is made by mixing aqueous salt solutions of cerium (IV) with salt solutions of trivalent rare earth(s). These salts can be any salts that are soluble in aqueous solutions, including for example nitrates. In certain embodiments, the trivalent rare earth dopants can be selected from the group consisting of yttrium (Y), lanthanum (La), neodymium (Nd), praseodymium (Pr), and mixtures thereof. The concentration of the aqueous salt solutions utilized can be about 0.02 to about 3 mol/L.

The mixture is then hydrothermally conditioned by refluxing for a set amount of time at a temperature of about 60 to about 120° C. and for a time of about 10 min to about 2 hours. The conditioned solution is then treated with base, such as sodium hydroxide (NaOH) or ammonium hydroxide (NH₄OH), to affect precipitation. The resulting solid is washed with water and thermally treated to obtain the trivalent doped cerium oxide composition. The thermal treatment can be at a temperature of about 550 to about 800° C. and for a time of about 10 min to about 2 hours. This final thermal treatment dries the resulting solid.

The trivalent doped cerium oxide composition then can be used to prepare the compositions disclosed herein for removing biological contaminants comprising a support material and the trivalent doped cerium oxide composition, wherein the trivalent doped cerium oxide composition is deposited on or within the support material.

### Preparing Compositions and Articles

The compositions as disclosed herein contain the trivalent doped cerium oxide and a support material. The trivalent doped cerium is prepared as described above. The support material is selected from an organic polymer, cotton, glass fiber, or mixtures thereof. This composition of the trivalent doped cerium oxide and support material independently may be used for treating gaseous or aqueous mixtures. Or the composition of the trivalent doped cerium oxide and support material may be incorporated into an article specifically designed for treating gaseous or aqueous mixtures, such as a filter or a plastic container. The filter may be a fixed bed. The filter may be used for a gaseous or aqueous mixture or stream and thus to filter the gaseous or aqueous mixture or stream.

The trivalent doped cerium oxide composition is deposited onto a support material or within the support material to provide the composition for removing biological contaminants.

The trivalent doped cerium oxide can be deposited on one or more external and/or internal surfaces of the support material. It can be appreciated that persons of ordinary skill in the art generally refer to the internal surfaces of the support material as pores. The trivalent doped cerium oxide composition can be supported on the support material with or without a binder. In some embodiments, the trivalent doped cerium oxide composition can be applied to the support material using any conventional techniques such as slurry deposition.

Processes of preparing the compositions disclosed herein are not limited by any particular steps or methods, and generally can be any that result in the incorporation of the trivalent doped cerium oxide into a support material or deposited onto a support material. Processes to incorporate the trivalent doped cerium oxide into a support material include mixing the trivalent doped cerium oxide into the support material production. As an example, the trivalent doped cerium oxide can be added and to molten polypropylene in the molding process. As another example, the trivalent doped cerium oxide can be added to a mixture of polyvinyl chloride resin, a plasticizer, and a stabilizer and passed through a hot mixer followed by an extruder.

Processes to deposit the trivalent doped cerium oxide onto a support material include mixing the trivalent doped cerium oxide with an organic binder either as a liquid or in an aqueous solution. The mixture of trivalent doped cerium oxide and organic binder is then bound to the support material by immersion of the support material or by coating the support material with the mixture by spreading or air brushing. The organic binder also can be used in slurry deposition techniques.

In certain embodiments, the organic binder is selected from the group consisting of citric acid, polyurethane diol, polyvinyl alcohol, polyvinylpyrollidone, linseed oil, and mixtures thereof. Once the trivalent doped cerium oxide is bound to the support material, the support as coated optionally may be rinsed with water prior to drying to remove residual not bound to the support. The coated support can then be optionally dried at temperatures above about 20° C. and below about 300° C. for about 1-12 hours or until sufficiently dry. In certain embodiments, the coated support can then be optionally dried at temperatures above about 20° C. and below about 120° C.

In the case of support materials that can melt, such as glass or plastics, the support can be heated to the point where the surface just begins to soften, then the trivalent doped cerium oxide can be placed on the surface such that it begins to mix with the semi-molten material. Upon cooling and resolidifying the trivalent doped cerium oxide is incorporated into the surface of the support material. The temperature utilized would depend on the support material utilized. One of skill in the art readily would be able to determine the appropriate temperature for the support material being utilized. For example, this temperature for quartz glass would be over 1000° C.; borosilicate glass would be about 500-600° C.; and PVC would be about 200-300° C.

These solid supports can be utilized to form articles including filters and plastic articles.

The trivalent doped cerium oxide compositions also may be incorporated into an article for a high touch surface and this high touch surface may come into contact with biological contaminants by direct touch contact. As such, articles for high touch surfaces also may be utilized in reducing bacteria and/or viruses deposited through contact and not necessarily just in treating fluids. These articles may be containers for liquids, elevator buttons, hand railing covers for escalators or stairs, a door, door handle, door knob, coverings on public transportation, touch pads for electronic transactions, fabrics, and the like.

The compositions containing the trivalent doped cerium oxide and support material can be formed into an elastic or rigid article, such as a filter, a fixed bed filtration system, a bottle or container, a high touch surface, and the like. In specific embodiments the article is a plastic article. In other embodiments, the article is a filter. These articles may contain any additional necessary components that such articles ordinarily contain, as well recognized by those of skill in the art. Techniques for forming these articles are well known to those of skill in the art.

### Methods for Using the Compositions Containing Trivalent Doped Cerium Oxide

The present application relates to methods for removing biological contaminants using the disclosed compositions containing trivalent doped cerium oxide. In certain embodiments, the present application relates to methods for removing and ensuring a target concentration or less of biological contaminants using the disclosed compositions containing trivalent doped cerium oxide. These biological contaminants include bacteria, viruses, protozoa (e.g., amoebae), fungi, algae, yeast, and the like. These methods may treat fluids (e.g., an aqueous or gaseous stream) or surfaces of solid objects through touch/direct contact. As such, the methods disclosed herein include methods for treating fluids (e.g., aqueous and/or gaseous streams).

In certain embodiments of the methods, an aqueous or gaseous stream is contacted with the compositions containing trivalent doped cerium oxide. In other embodiments of the methods, a potentially contaminated surface is contacted with the compositions containing trivalent doped cerium oxide. These potentially contaminated surfaces include, for example, skin (e.g., a hand, finger, palm, etc.) and the contact is through touching the compositions or articles containing trivalent doped cerium oxide. In the methods as disclosed herein, the biological contaminant to be removed may be contained within an aqueous or gaseous stream or may be on the surface of the physical object.

While not wanting to be bound by any theory, it is believed that the contacting of the trivalent doped cerium oxide with the biological contaminant leads to the biological contaminant one or more of sorbing and/or reacting with the trivalent doped cerium oxide or deactivating when contacted with the trivalent doped cerium oxide. The sorbing, reacting, and/or deactivating of the biological contaminant with the trivalent doped cerium oxide removes the biological contaminant from the biological contaminant-containing fluid (air or aqueous stream) or the solid surface.

The biological contaminant may be removed to a target level or to below a target level. In some embodiments the biological contaminant may be removed to a level at which it is undetectable. The target level may be a specified amount or the limit of detection. As part of the methods described herein, the biological contaminant to be removed may be identified and the target amount or level for the contaminant may be set. For certain of the biological contaminants contemplated herein, the target amount or level would be any detectable amount. The methods optionally may additionally comprise monitoring the treated stream for the contaminant.

The methods disclosed herein may be used to treat air or water or may be used to treat contaminants through contact by touch. When used to treat contaminants by contact through touch, the disclosed compositions are incorporated into a high touch surface.

Using the disclosed compositions containing trivalent doped cerium oxide to treat biological contaminated air and/or water allows for the efficient operation of air and/or water treatment methods and provides a treated stream with reduced concentrations of biological contaminant. As disclosed herein, the trivalent doped cerium oxide compositions may be incorporated into an article specifically designed for treating gaseous or aqueous mixtures, such as a filter, a fixed bed filtration system, or in a plastic for a container.

Although the methods of the disclosure are envisioned for removing biological (e.g., bacterial, viral, amoebae, etc.) contaminants from air and/or drinking water and groundwater, it will be understood that the process can be used to treat any gaseous or aqueous liquid feed that contains undesirable amounts of biological contaminants. The methods also are envisioned for removing biological contaminants through direct contact of a contaminated surface with an article containing the trivalent doped cerium oxides.

In certain embodiments, these methods comprise (i) providing a composition comprising a support material comprising an organic polymer, cotton, glass fiber, or mixture thereof and a trivalent doped cerium oxide composition comprising a cerium oxide doped with a trivalent dopant selected from the group consisting of yttrium (Y), lanthanum (La), neodymium (Nd), praseodymium (Pr), and mixtures thereof; (ii) contacting the composition with a biological contaminant wherein the biological contaminant is selected from the group consisting of bacteria, viruses, fungi, protozoa, and mixtures thereof; and (iii) removing biological contaminant through contact with the composition. The biological contaminant can be contained in an aqueous or liquid stream or on the surface of an object that is physically contacted with the composition containing the trivalent doped cerium oxide. These methods may further comprise monitoring for the biological contaminant after contacting. The monitoring may be done by sampling or may be continuous.

In specific embodiments, these methods comprise (i) providing a composition comprising a support material comprising an organic polymer, cotton, glass fiber, or mixtures thereof, and a trivalent doped cerium oxide composition consisting of a cerium oxide doped with a trivalent dopant selected from the group consisting of yttrium (Y), lanthanum (La), neodymium (Nd), praseodymium (Pr), and mixtures thereof; (ii) contacting the composition with a biological contaminant wherein the biological contaminant is selected from the group consisting of bacteria, viruses, fungi (e.g., mold), protozoa (e.g., amoebae), and mixtures thereof; and (iii) removing biological contaminant through contact with the composition. The biological contaminant can be contained in an aqueous or liquid stream or on the surface of an object that is physically contacted with the composition containing the trivalent doped cerium oxide. These methods may further comprise monitoring for the biological contaminant after contacting. The monitoring may be done by sampling or may be continuous.

The contacting of the trivalent doped cerium oxide with the biological contaminant leads to removal of a measurable amount of the biological contaminant. In some embodiments, the contacting removes at least about 90% of the biological contaminant. In other embodiments, the contacting removes at least 95%, or more preferably 99% or 99%+of the biological contaminant.

Contacting of the trivalent doped cerium oxide with biological contaminant effectively reduces the amount of biological contaminant, and in certain embodiments, it effectively reduces the amount of biological contaminant in a gaseous or aqueous stream. The removal also can be expressed as a percent reduction in concentration of the biological contaminant. In some embodiments, the contacting of the trivalent doped cerium oxide with the biological contaminant can reduce its concentration by more than about 75%. More typically, the contacting of the trivalent doped cerium oxide composition with the biological contaminant can reduce its concentration by more than about 80%, more typically more than about 85%, more typically more than about 90%, more typically more than about 95%, more typically more than about 97.5%, more typically more than about 99%, and even more typically more than about 99.5%.

In specific embodiments, these methods may be for removing biological contaminants from fluid or for treating fluid. In these embodiments, the fluid may be a gaseous or aqueous stream. In these embodiments, the methods comprise (i) providing a composition comprising a support material comprising an organic polymer, cotton, glass fiber, or mixture thereof and a trivalent doped cerium oxide composition comprising a cerium oxide doped with a trivalent dopant selected from the group consisting of yttrium (Y), lanthanum (La), neodymium (Nd), praseodymium (Pr), and mixtures thereof; (ii) contacting a biological contaminant containing gaseous or aqueous stream with the composition, wherein the biological contaminant is selected from the group consisting of bacteria, viruses, fungi (e.g., mold), protozoa (e.g., amoebae), and mixtures thereof; and (iii) removing biological contaminant from the gaseous or aqueous stream through contact with the composition. The biological contaminant can be removed in an amount of 90% or more. These methods may further comprise monitoring for the biological contaminant after contacting. The monitoring may be done by sampling or may be continuous.

These methods of treating a gaseous or aqueous stream may further comprise a step of setting a target concentration of biological contaminant. In these methods a biological contaminant of interest is identified and then a target concentration for that biological contaminant is set. The methods additionally may comprise a step of monitoring the biological contaminant in the treated stream. The monitoring may be done by sampling or may be continuous.

In certain embodiments, the methods comprise the steps of (i) providing a composition comprising a support material comprising an organic polymer, cotton, glass fiber, or mixture thereof and a trivalent doped cerium oxide composition comprising a cerium oxide doped with a trivalent dopant selected from the group consisting of yttrium (Y), lanthanum (La), neodymium (Nd), praseodymium (Pr), and mixtures thereof; (ii) setting a target concentration of a biological contaminant; (iii) contacting a gaseous or aqueous stream with the composition, and removing biological contaminant through contact with the composition to provide a treated stream; and (iv) monitoring the treated stream for the biological contaminant, wherein the biological contaminant is selected from the group consisting of bacteria, viruses, fungi (e.g., mold), protozoa (e.g., amoebae), and mixtures thereof. The target concentration can be set at a certain amount of contaminant (e.g., virus, bacteria, protozoa/amoebae, or fungi) or can be set at the limit of detection. Monitoring of the biological contaminant can be performed through techniques well known to those of skill in the art. The monitoring may be done by sampling or may be continuous. One of skill in the art understands real-time and continuous monitoring techniques for microbial contaminants, including viruses, bacteria, protozoa/amoebae, fungi, and the like. These techniques include optical techniques and cell counters.

In specific embodiments of treating an aqueous stream, the methods comprise (i) providing a composition comprising a support material comprising an organic polymer, cotton, glass fiber, or mixture thereof and a trivalent doped cerium oxide composition comprising a cerium oxide doped with a trivalent dopant selected from the group consisting of yttrium (Y), lanthanum (La), neodymium (Nd), praseodymium (Pr), and mixtures thereof; (ii) contacting the aqueous stream with the composition and removing biological contaminant through contact with the composition to provide a treated aqueous stream, wherein the biological contaminant is selected from the group consisting of bacteria, viruses, fungi (e.g., mold), protozoa (e.g., amoebae), and mixtures thereof. These methods may further comprise monitoring for the biological contaminant after contacting. The monitoring may be done by sampling or may be continuous. In specific embodiments the methods may further comprise setting a target concentration of a biological contaminant and monitoring the treated aqueous stream for the biological contaminant. The target concentration may be a specified amount or the limit of detection.

In specific embodiments of treating a gaseous stream, the methods comprise the methods comprise (i) providing a composition comprising a support material comprising an organic polymer, cotton, glass fiber, or mixture thereof and a trivalent doped cerium oxide composition comprising a cerium oxide doped with a trivalent dopant selected from the group consisting of yttrium (Y), lanthanum (La), neodymium (Nd), praseodymium (Pr), and mixtures thereof; (ii) contacting the gaseous stream with the composition and removing biological contaminant through contact with the composition to provide a treated gaseous stream, wherein the biological contaminant is selected from the group consisting of bacteria, viruses, fungi (e.g., mold), protozoa (e.g., amoebae), and mixtures thereof. These methods may further comprise monitoring for the biological contaminant after contacting. The monitoring may be done by sampling or may be continuous. In specific embodiments the methods may further comprise setting a target concentration of a biological contaminant and monitoring the treated gaseous stream for the biological contaminant. The target concentration may be a specified amount or the limit of detection.

When the biological contaminant is bacteria or fungi/mold, the removal can be expressed as a % reduction that is determined by using Colony Forming Units (CFU). In these embodiments, the concentration of bacteria contaminant after contacting with the composition comprising the trivalent doped cerium oxide composition can be about 45 colony forming units CFU/ml to 5×10⁵ CFU/ml.

When the biological contaminant are bacteria and/or viruses, the removal can be expressed as a % reduction that is determined by using Most Probable Number (MPN) technique. Most Probable Number (MPN) is used to estimate the concentration of viable microorganisms in a sample by means of replicating liquid broth growth in ten-fold dilutions.

A target concentration for biological contaminant also can be set as a percentage reduction of the contaminant from prior to the method and then after contact in the method. In certain embodiments, this percent reduction can be about 75% to about 100% less. In other embodiments, this percent reduction can be about 80% to about 99.9%.

A target concentration for biological contaminant can be set at a limit of detection for that contaminant. As described above, in embodiments including setting a target concentration for biological contaminant, the methods may further comprise one or more of the following additional steps: identifying the biological contaminant of interest; setting the target concentration; and monitoring for the biological contaminant after the contacting step to determine or verify that the biological contaminant is below the target concentration. Depending on the biological contaminant, the target concentration can be any detectable amount of that contaminant and the methods as disclosed herein are effective in treating the aqueous or gaseous stream as long as no amount of that contaminant is detected in the treated stream. In specific of these embodiments, the stream to be treated can be an aqueous stream and the targeted contaminant can be bacteria, virus, or protozoa (e.g., amoebae). For example, the stream to be treated is an aqueous or gaseous stream and the targeted contaminant can be E. coli, poliovirus, coronavirus, Naegleria fowleri, paramyxovirus, Mycobacterium tuberculosis, Legionella pneumophila, coronavirus or a mixture thereof. In certain embodiments, the stream to be treated is an aqueous stream and the targeted contaminant is E. coli, poliovirus, Naegleria fowleri, Legionella pneumophila, coronavirus, or a mixture thereof. In certain embodiments, the stream to be treated is a gaseous stream and the targeted contaminant is paramyxovirus, Mycobacterium tuberculosis, coronavirus, or a mixture thereof.

These specific methods comprise the steps of (i) providing a composition comprising a support material comprising an organic polymer, cotton, glass fiber, or mixture thereof and a trivalent doped cerium oxide composition comprising a cerium oxide doped with a trivalent dopant selected from the group consisting of yttrium (Y), lanthanum (La), neodymium (Nd), praseodymium (Pr), and mixtures thereof; (ii) setting a target concentration of a biological contaminant wherein the contaminant is selected from the group consisting of E. coli, poliovirus, coronavirus, Naegleria fowleri, paramyxovirus, Mycobacterium tuberculosis, Legionella pneumophila, coronavirus or a mixture thereof; (ii) contacting a gaseous or aqueous stream with the composition, and removing biological contaminant through contact with the composition to provide a treated stream; and (iii) monitoring the treated stream for the biological contaminant. The target concentration can be set at a certain amount of contaminant or can be set at the limit of detection. The method also can include a step of identifying the contaminant of interest prior to setting the target concentration.

Examples of gaseous feeds that can be treated according to the methods as disclosed herein include, among others, building ventilation systems, aircraft or vehicle ventilation systems, and ambient room air. Examples of liquid feeds that can be treated according to the methods as disclosed herein include, among others, tap water, well water, surface waters, such as water from lakes, ponds and wetlands, waters for recreational activities, agricultural waters, wastewater from industrial processes, and geothermal fluids. Examples of other uses involving physical contact with biological contaminants rather than filter, include incorporation into a plastic for a container or a plastic to be incorporated into a high touch surface, such as elevator buttons, escalator railing covers, stair railing covers, touch pads for electronic transactions, doors, door knobs, and the like. These high touch surfaces also may include glass or a mixture of glass and plastic.

The trivalent doped cerium oxide compositions can remove bacteria, viruses, protozoa (e.g., amoebae), fungi, and other microbial contaminants and in some embodiments remove the bacteria, viruses, protozoa (e.g., amoebae), fungi, and mixtures thereof from a gaseous or liquid feed.

In one embodiment, the process is envisioned for removing biological contaminants from a gaseous or an aqueous stream using the trivalent doped cerium oxide compositions. The gaseous stream can be one or more of an ambient air source or more supply air for a ventilation system that contains or may contain undesirable amounts of biological and/or other contaminants. The aqueous stream can be one or more of a drinking water and groundwater source that contains or may contain undesirable amounts of biological and/or other contaminants. Furthermore, the aqueous stream can include without limitation well waters, surface waters (such as water from lakes, ponds, and wetlands, including natural and man-made and water for recreational purposes), agricultural waters, wastewater from industrial processes, and geothermal waters.

In some embodiments, the biological contaminant-containing gaseous stream is passed through an inlet into a vessel at a temperature and pressure, usually at ambient temperature and pressure, such that the gas in the biological contaminant-containing gaseous stream remains in the gaseous state. In this vessel the biological contaminant-containing gaseous stream is contacted with the trivalent doped cerium oxide composition. The contacting of the trivalent doped cerium oxide with the biological contaminant-containing gaseous stream removes the biological contaminant. The contacting of the trivalent doped cerium oxide with the biological contaminant-containing gaseous stream leads to removal of a measurable amount of the biological contaminant and in some embodiments removal of at least 90%, more preferably 95%, and even more preferably 99% or 99%+of the biological contaminant.

In some embodiments, the biological contaminant-containing aqueous stream is passed through an inlet into a vessel at a temperature and pressure, usually at ambient temperature and pressure, such that the water in the biological contaminant-containing aqueous stream remains in the liquid state. In this vessel the biological contaminant-containing aqueous stream is contacted with the trivalent doped cerium oxide composition. The contacting of the trivalent doped cerium oxide with the biological contaminant-containing aqueous stream leads to removal of a measurable amount of the biological contaminant and in some embodiments removal of at least 90%, more preferably 95%, and even more preferably 99% or 99%+of the biological contaminant.

In some embodiments, the trivalent doped cerium oxide composition is in the form of a fixed bed. Moreover, the fixed bed containing the trivalent doped cerium oxide composition normally comprises particles containing the trivalent doped cerium oxide. The trivalent doped cerium oxide particles can have a shape and/or form that exposes a maximum trivalent doped cerium oxide particle surface area to the gaseous or aqueous fluid with minimal back-pressure and the flow of the gaseous or aqueous fluid through the fixed bed. However, if desired, the trivalent doped cerium oxide particles may be in the form of a shaped body such as beads, extrudates, porous polymeric structures or monoliths. The trivalent doped cerium oxide composition can be supported as a layer and/or coating on such beads, extrudates, porous polymeric structures or monolith supports.

Contacting of the trivalent doped cerium oxide composition with a biological contaminant-containing fluid normally takes place at a temperature from about 1 to about 100 degrees Celsius, more normally from about 5 to about 40 degrees Celsius. Furthermore, the contacting of trivalent doped cerium oxide with a biological contaminant-containing aqueous stream commonly takes place at a pH from about pH 1 to about pH 11, more commonly from about pH 3 to about pH 9. The contacting of the trivalent doped cerium oxide composition with biological contaminant-containing fluid generally occurs over a period of time of more than about 30 seconds and no more than about 24 hours.

Generally, the trivalent doped cerium oxide compositions can be used to treat any biological contaminant, and in particular bacteria, viruses, protozoa (e.g., amoebae), fungi, yeast, and mixtures thereof. The trivalent doped cerium oxide of the present disclosure has a number of properties that are particularly advantageous for biological contaminant removal. Contacting of the trivalent doped cerium oxide compositions with a gaseous or aqueous stream containing the biological contaminant effectively can reduce the biological contaminant level in the gaseous or aqueous stream. Typically, the contacting of the trivalent doped cerium oxide with the biological contaminant can reduce its concentration by more than about 75%. More typically, the contacting of the trivalent doped cerium oxide composition with the biological contaminant can reduce its concentration by more than about 80%, more typically more than about 85%, more typically more than about 90%, more typically more than about 95%, more typically more than about 97.5%, more typically more than about 99%, and even more typically more than about 99.5%. When the biological contaminant is bacteria or mold, the % reduction can be determined by number using Colony Forming Units (CFU). When the biological contaminant is bacterial or viruses, the % reduction can be determined by Most Probable Number (MPN).

The method of treating air or water to remove biological contaminants comprises the steps of passing an air or water stream containing a first concentration of one or more undesired biological contaminants through a material or composition comprising the trivalent doped cerium oxide composition and obtaining a treated air or water stream having a concentration of one or more undesired biological contaminants less than the first concentration.

In certain embodiments, the biological contaminants to be removed are viruses. After contacting with the article or composition comprising the trivalent doped cerium oxide composition, the concentration of virus can be equal to or less than a target concentration of virus. When an air or gaseous stream is to be treated, the contacted (or treated) stream has a concentration of virus equal to or less than a target concentration of virus. In particular of these embodiments, the viruses are coronavirus.

In certain embodiments, the biological contaminants to be removed are bacteria. After contacting with the article or composition comprising the trivalent doped cerium oxide composition, the concentration of bacteria can be equal to or less than a target concentration of bacteria. When an air or gaseous stream is to be treated, the contacted (or treated) stream has a concentration of bacteria equal to or less than a target concentration of bacteria. In particular of these embodiments, the bacteria are fecal coliform bacteria.

In certain embodiments, the biological contaminants to be removed are protozoa (e.g., amoebae). After contacting with the article or composition comprising the trivalent doped cerium oxide composition, the concentration of protozoa (e.g., amoebae) can be equal to or less than a target concentration of protozoa (e.g., amoebae). When an air or gaseous stream is to be treated, the contacted (or treated) stream has the concentration of protozoa (e.g. amoebae) equal to or less than a target concentration of protozoa (e.g., amoebae). In particular of these embodiments, the protozoa (e.g., amoebae) to be removed are Naegleria fowleri and/or Cryptosporidum.

In certain embodiments, the biological contaminants to be removed are fungi (e.g., mold). After contacting with the article or composition comprising the trivalent doped cerium oxide composition, the concentration of fungi can be equal to or less than a target concentration of fungi. When an air or gaseous stream is to be treated, the contacted (or treated) stream has a concentration of fungi equal to or less than a target concentration of fungi. In particular of these embodiments, the fungi to be removed are Trichophyton mentagrophytes and/or Aspergillus.

The concentration of contaminant after contacting with a composition or material comprising the trivalent doped cerium oxide composition can be about 45 colony forming units CFU/ml to 5×10⁵ CFU/ml. The target concentration can be set at a certain amount of contaminant (e.g., virus, bacteria, amoeba, fungi) CFU per ml or can be set at the limit of detection.

### EXAMPLES

The following Examples are provided to illustrate the trivalent doped cerium oxide composition and methods in more detail, although the scope of the invention is never limited thereby in any way.

Scanning electron microscope (SEM) images were collected using a FEG Zeiss ultra 55 (resolution 1 nm). Transmission electron microscope (TEM) images were collected using a FEI Titan Themis 200 (resolution 0.09 nm). Surface area, pore radius, and pore volume were measured by the BET/BJH method (ASTM D3663-20). The Hg-porosity and total Hg-pore volume were measured using a Micromeritics Autopore IV 9500 system. The procedures outlined in ASTM International test method D 4284-07 were followed. The particle size was measured using a Microtrac S3500. X-ray Diffraction was performed using a Bruker D2 Phaser X-Ray Diffactometer. The peak width at half height was used to determine the crystallite size. The zeta potential vs. pH was measured using a Malvern Panalytical (Zetaziser Nano ZS) ZEN3600 using a procedure similar to ASTM E2865-12(2018). As will be appreciated, crystallite sizes are measured by XRD or TEM and are the size of the individual crystals. The Dₓₓ sizes are the size of the particles that are made-up of the individual crystallites and is measured by laser diffraction.

### Example 1

A trivalent doped cerium oxide composition was prepared by the following method. 129 ml of a 1 mol/L Ce(NO₃)₄ solution was mixed with 22 ml of a 1 mol/L La(NO₃)₃ solution and 1.56 ml of a 1 mol/L Nd(NO₃₃ solution. The resulting solution was heated to reflux for at least 2 hours. 5.5 mol/L NH₄OH was then added to a pH of 10. The resulting solid was filtered and washed with DI water until the wash water was <15 mS/cm. The resulting powder was heated in a furnace in air at 550° C. for at least 2 hours to obtain a La/Nd doped cerium oxide.

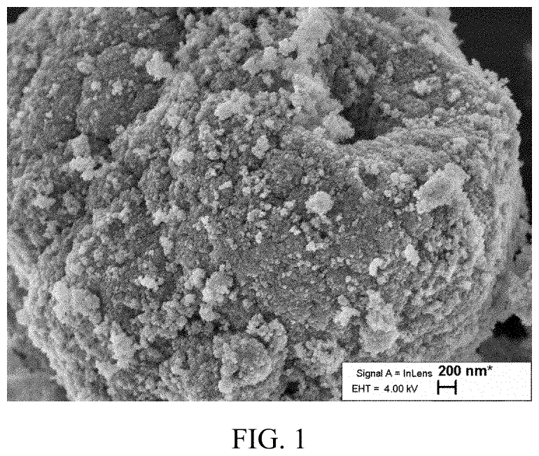

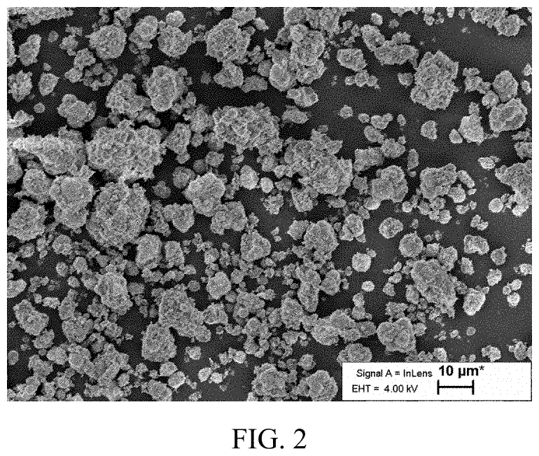

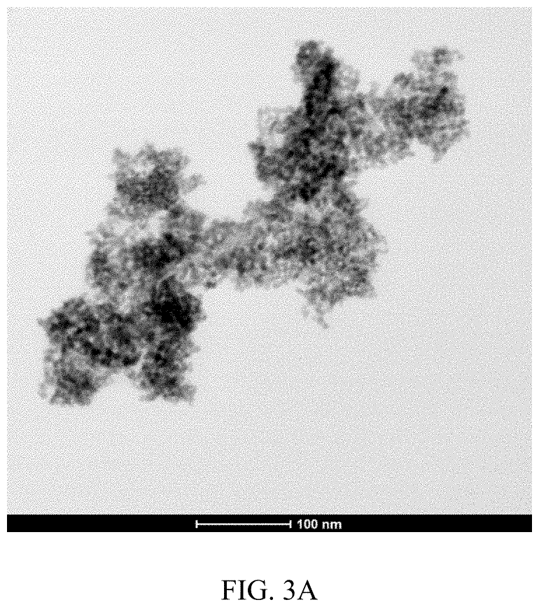

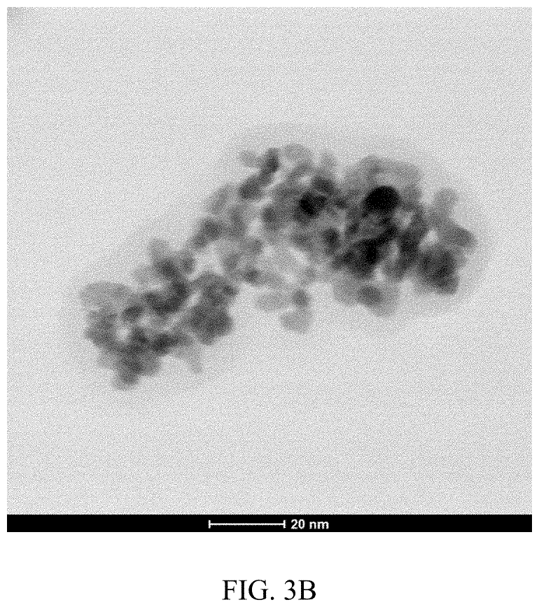

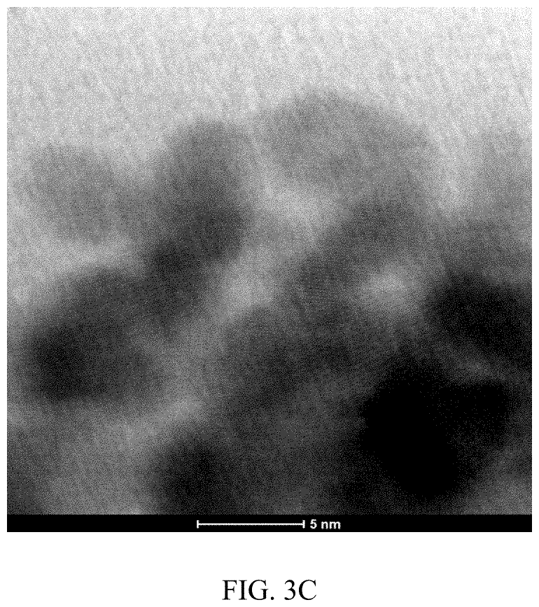

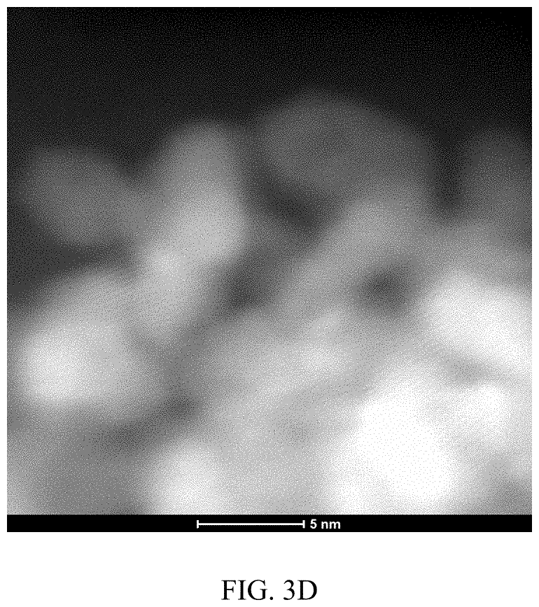

FIGS. 1 and 2 are the SEM images of the example 1 composition. The images reveal a porous material that somewhat spherical in shape. TEM images for the example 1 composition are in FIGS. 3A-3D. The images reveal clusters of spheres and diffraction planes can be seen. The surface area was found to be 124.83 m²/g (BET) and 98.34 m²/g (BJH) with a pore radius of 3.413 nm and pore volume of 0.25 cc/g. The measured Hg-pore volume with pore size <0.1 μm was measured to be 0.2 cc/g, with pore size <1 μm was 0.36 cc/g, and the total Hg-pore volume was 0.88 cc/g. The particle size distribution was measured with the results being D10 1.468 μm, D50 7.149 μm, and D90 15.547 μm. The x-ray diffraction pattern shows peaks which resemble the known pattern for CeO₂. The peak width at half height was used to determine the crystallite size and the result was 86.7 nm. The zeta potential at pH 7 was found to be approximately 15.6 mV and the isoelectric point was determined to be pH 7.44.

### Comparative Example 1

A cerium (IV) oxide composition was prepared by the following method. In a closed, stirred container a one liter of a 0.12 M cerium (IV) ammonium nitrate solution was prepared from cerium (IV) ammonium nitrate crystals dissolved in nitric acid and held at approximately 90° C. for about 24 hours. In a separate container 200 ml of a 3M ammonium hydroxide solution was prepared and held at room temperature. Subsequently the two solutions were combined and stirred for approximately one hour. The resultant precipitate was filtered using Buckner funnel equipped with filter paper. The solids were then thoroughly washed in the Buckner using deionized water. Following the washing/filtering step, the wet hydrate was calcined in a muffle furnace at approximately 450° C. for three hours to form the cerium (IV) oxide composition.

The cerium (IV) oxide composition of comparative example 1 has a zeta-potential of approximately 9.5 mV at a pH of 7, an isoelectric point at about pH 9.1, a surface area between 110 and 150 m²/g, a particle size D₁₀ of approximately 2 μm, a particle size D₅₀ of approximately 9 μm, a particle size D90 of approximately 25 μm, and a crystallite size of approximately 10 nm.

### Example 2

A trivalent doped cerium oxide composition was prepared by the following method. 129 ml of a 1 mol/L Ce(NO₃)₄ solution was mixed with 24 ml of a 1 mol/L La(NO₃)₃ solution. The resulting solution was heated to reflux for at least 2 hours. 5.5 mol/L NH₄OH was then added to a pH of 10. The resulting solid was filtered and washed with DI water until the wash water was <15 mS/cm. The resulting powder was heated in a furnace in air at 550° C. for at least 2 hours to obtain a La doped cerium oxide.

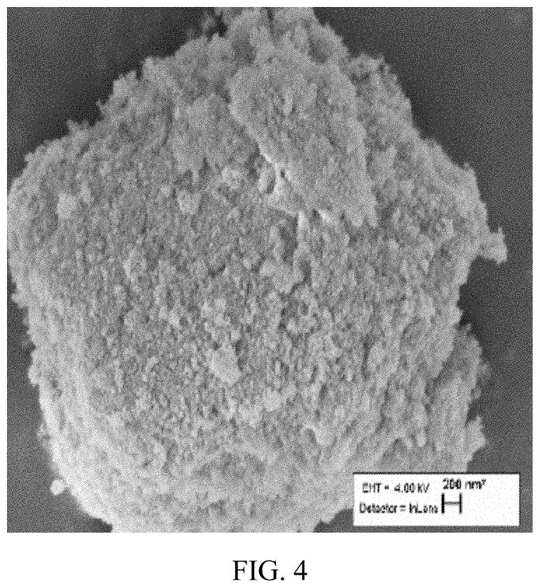

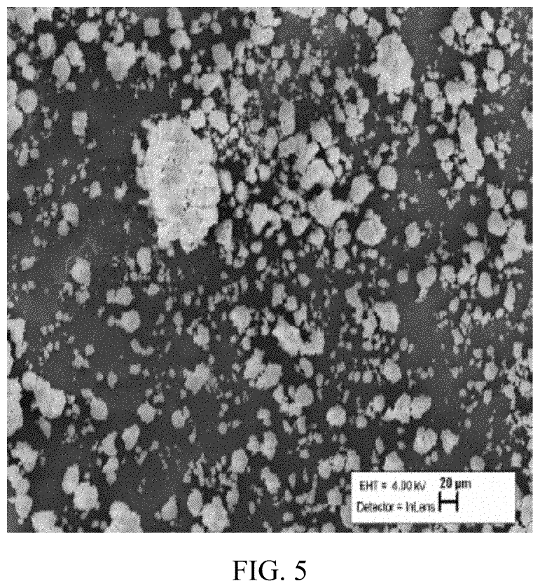

Scanning electron microscope (SEM) images of the example 2 composition are in FIGS. 3 and 4. The images reveal a porous material that somewhat spherical in shape. Transmission electron microscope (TEM) images for the example 2 composition are in FIG. 5. The images reveal clusters of spheres and diffraction planes can be seen. The surface area was found to be 120.464 m²/g (BET) and 143.087 m²/g (BJH) with a pore radius of 3.245 nm and pore volume of 0.285 cc/g. The measured Hg-pore volume with pore size <0.1 μm was measured to be 0.23 cc/g, with pore size <1 μm was 0.45 cc/g, and the total Hg-pore volume was 0.99 cc/g. The particle size distribution was measured as described above with the results being D10 1.301 μm, D50 5.545 μm, and D90 13.109 μm.

### Example 3

Bacterial removal characteristics were measured by the following procedure. On the day of the study, the bacteria culture was examined for purity and concentration. The referenced bacteria (Methicillin-resistant Staphylococcus aureus or Escherichia coli) was homogenized for 30 seconds and allowed a 15-minute rest. The microbial challenge was checked for purity, and then diluted in phosphate buffered saline (PBS). The test was then performed in duplicate as follows: One hundred microliters of a single diluted bacterial species suspension was added to a 50 mL conical tube (Corning) containing 0.25 g of the test material suspended in 25 mL of Sterile DI Water and a NIST traceable laboratory timer was started immediately. The mixture was homogenized at medium speed by vortexing periodically for a total contact time of 30-seconds, 5-minutes, or 30-minutes. Immediately following, 1 mL of the sample was transferred to a fresh 50 mL tube containing 9 mL of D/E Neutralizing Broth (Criterion) and homogenized. The samples were analyzed on the day of the study directly and at various dilutions in replicates of at least 2. Positive and negative controls were performed along with the test subjects to provide quality control and reference data as per laboratory standard accredited ISO17025:2017 methodology. Bacteria were analyzed and enumerated as Colony Forming Units (CFU) on the respective media as per SM 9215C. The respective percent reductions were determined based on the recovery of the positive controls and test samples.

TABLE 1
Reduction of MRSA by the composition of Example 1.

| | | Initial MRSA | Final MRSA | |
|---|---|---|---|---|
| | | CFU concentration | CFU concentration | |
| | | before treatment | after treatment | |
| | | with the composition | with the composition | |
| Contact | | of Example 1 | of Example 1 | % |
| time | | (CFU/mL) | (CFU/mL) | Reduction |
| 30 | seconds | 4.91 × 10⁵ | 2260 | 99.5% |
| 5 | min | 5 × 10⁵ | 1610 | 99.7% |
| 30 | mins | 1.55 × 10⁵ | 342 | 99.8% |

TABLE 2
Reduction of E. coli by the composition of Example 1.

| | | Initial E. coli | Final E. Coli | |
|---|---|---|---|---|
| | | CFU concentration | CFU concentration | |
| | | before treatment | after treatment | |
| | | with the composition | with the composition | |
| Contact | | of Example 1 | of Example 1 | % |
| time | | (CFU/mL) | (CFU/mL) | Reduction |
| 30 | seconds | 5 × 10³ | 1.8 | 99.96% |
| 5 | min | 2 × 10³ | <0.45 | >99.97% |

### Example 4

Viral Removal Characteristics of the composition of Example 1. An aliquot of the referenced virus was added to Sterile DI Water and homogenized. 25 mL of the prepared test water was added to a 50 mL conical tubes (Corning) containing 0.25 g of the test material and a NIST traceable laboratory timer was started immediately. The mixture was homogenized at medium speed on an orbital shaker a total contact time of 30-minutes. Immediately following, 1 mL of the sample was transferred to a fresh 50 mL tube containing 9 mL of DIE Neutralizing Broth (Criterion) and homogenized. The recovery control consisted of a sterile tube containing 25 mL of test water that was homogenized and treated in the same manner as the test substances. The samples analyzed on the day of the study directly and at various dilutions in replicates of at least 5. Positive and negative controls were performed along with the test subjects to provide quality control and reference data as per laboratory standard accredited ISO17025:2017 methodology. Poliovirus analysis was conducted using Buffalo Green Monkey (BGM) kidney Cell Monolayers as per method EPA 1615. Briefly, aliquots of a sample containing the virus were inoculated on freshly prepared monolayers of BGM cells. Each sample volume was inoculated in replicates of five. Each sample was analyzed using a minimum of five ten-fold dilutions The cells were then incubated in Dulbecco's Modified Eagle's medium (dMEM, Mediatech Inc, USA) media 2% Fetal Bovine Serum (FBS, Mediatech, USA) at 36.5° C. and 5% CO2 for 5 days. Cells were microscopically monitored routinely for signs of degeneration. Cells in flasks demonstrating signs of infectivity (Cytopathic effects; CPE) were recorded as positive (+) and those that did not demonstrate any CPE were recorded as negative (−). The Most Probable Number (1VIPN) of virus Infectious Units (IU) in a sample was then calculated using MPNCALC software (version 0.0.0.23). The respective percent reductions were determined based on the recovery of the positive controls and test samples. Human Coronavirus OC43 (ATCC VR-1558) virus was propagated and enumerated as Most Probable Numbers (MPN) using human ileocecal colorectal adenocarcinoma HCT-8 cell line (ATCC CCL-244) as the host. Cells were grown in 6-well plates cell culture flasks. For enumeration, virus was enumerated as infectious units as per the assay methodology described in Standard Method 9510 (APHA, 2012); the methodology is equivalent to EPA/600/R-95/178 and the updated EPA/600/4-84/013. Briefly, aliquots of a sample containing the virus were inoculated on freshly prepared monolayers of HCT8 cells (approximately 90% confluence). Each sample volume was inoculated in replicates of five. The cells were then incubated in Dulbecco's Modified Eagle's medium (dMEM, Mediatech Inc, USA) media 2% Fetal Bovine Serum (FBS, Mediatech, USA) at 35° C. and 5% CO₂ for 8-10 days. Cells were microscopically monitored routinely for signs of degeneration. Cells in flasks demonstrating signs of infectivity (Cytopathic effects; CPE) were recorded as positive (+) and those that did not demonstrate CPE were recorded as negative (−). The most probable number of infectious virus in a sample was then calculated using MPNCALC software (version 0.0.0.23). The respective percent reductions were determined based on the recovery of the positive controls and test samples.

TABLE 3
Reduction of Poliovirus by the composition of Example 1.

| | Initial Poliovirus | Final Poliovirus | |
|---|---|---|---|
| | Infective Units | Infective Units | |
| | concentration | concentration | |
| | before treatment | after treatment | |
| | with the composition | with the composition | |
| Contact | of Example 1 | of Example 1 | % |
| time | (MPN/mL) | (MPN/mL) | Reduction |
| 30 min | 9.2 × 10⁵ | 1600 | 99.8% |

TABLE 4
Reduction of Human Coronavirus OC43
by the composition of Example 1.

| | Initial OC43 | Final OC43 | |
|---|---|---|---|
| | Infective Units | Infective Units | |
| | concentration | concentration | |
| | before treatment | after treatment | |
| | with the composition | with the composition | |
| Contact | of Example 1 | of Example 1 | % |
| time | (MPN/mL) | (MPN/mL) | Reduction |
| 30 min | 1.3 × 10⁵ | 12 | 99.991% |

### Example 5

Viral Removal Characteristics of the cerium oxide composition of Comparative Example 1. A quantitative suspension test for the evaluation of virucidal activity in the medical area was performed. An enveloped DNA virus—vaccinia, a coronavirus surrogate, was selected for screening and comprised a cell culture medium of: Eagle's Minimum Essential Medium (EMEM)+10% FBS+2% Pen/Strep (Culture Media), EMEM+2% FBS+2% FCS+1% Pen/Strep (Viral Media). The product test concentration was 0.1±0.01 g/mL-1 and distilled water was used as the diluent. The suspended powder was liquid vortexed to uniformity. Contact analysis across two soak times of 30±5 minutes & 4±0.3 hours was conducted. The test temperature was maintained at 20±2 ° C. with an incubation condition of 37±2 ° C. and 5% CO₂. There were no interfering substances and the test products appeared normal and stable. The activity suppression method was one of dilution in ice-cold medium to promote passive settling. No filtration was used.

TABLE 5
Reduction of Vaccinia by the cerium oxide
composition of Comparative Example 1.

| | |
|---|---|
| Contact time | % Reduction |

| | | |
|---|---|---|
| 30 | mins | 90% |
| 4 | hours | 90% |

### Example 6

Spores of Trichophyton mentagrophytes were prepared as per ASTM E2197 (Standard Quantitative Disk Carrier Test Method for Determining Bactericidal, Virucidal, Fungicidal, Mycobactericidal, and Sporicidal Activities of Chemicals). An aliquot of the spore suspension was added to sterile DI water and homogenized. The test material was tested as follows: 25 mL of the prepared test water was added to a 50 mL conical tubes containing 0.25 g of the test material and a NIST traceable laboratory timer was started immediately. The mixture was homogenized at medium speed on a rotary mixer for a contact time of 30 and 60 minutes. Immediately following each contact time, 1 mL of the sample was transferred to a fresh 50 mL tube containing 9 mL of D/E Neutralizing Broth (Criterion) and homogenized. The recovery control consisted of a sterile tube containing 25 mL of prepared test water that was homogenized and treated in the same manner as the test substances. On the day of the study, the fungal spore suspension was examined for purity and concentration. The samples were analyzed on the day of the study directly and at various dilutions in replicates of at least 2. Positive and negative controls were performed along with the test subjects to provide quality control and reference data as per laboratory standard accredited ISO17025:2017 methodology. Fungi were analyzed and enumerated as Colony Forming Units (CFU) on rose bengal agar (BD Difco) as per SM 9215C. The respective percent reductions were determined based on the recovery of the positive controls and test samples.

TABLE 6
Reduction of Trichophyton mentagrophytes
by the composition of Example 1.

| Contact time | % Reduction |
|---|---|
| 30 min | 91.8% |
| 60 min | 95.5% |

### Example 7

The material of example 1 is suspended in deionized water and a binder, such as citric acid, is added to the water. A substrate, such as cotton fabric, is then immersed in the suspension at least one time. After removing the substrate, it is allowed to dry. The resulting fabric has a coating of the composition of example 1 its surface. This coated fabric is then placed in a funnel such that fabric will remain in the funnel when water is passed through. Water contaminated with E. coli is then poured into the funnel and comes in contact with the coated fabric. The water collected from the funnel is analyzed and found to have a reduced concentration of E. coli.

### Example 8

The material of example 1 is suspended in deionized water and a binder, such as citric acid, is added to the water. A substrate, such as cotton fabric, is then immersed in the suspension at least one time. After removing the substrate, it is allowed to dry. The resulting fabric has a coating of the composition of example 1 its surface. This coated fabric is then placed on an air filter such that fabric covers the face of the air filter and air can pass though the fabric. The filter is then placed in an HVAC or room air filtration unit. Upon turning on the unit, air contaminated with coronavirus is passed through the filter. The air discharged from the unit is analyzed and found to have a reduced concentration of coronavirus.

### Example 9

Polyethylene granules or powder is mechanically mixed with the material of example 1 such that the material of example 1 is approximately 1% by weight. The mixture is then fed into a heating chamber to form an end use product such as a bottle. After the bottle is formed from the polyethylene containing material from example 1, the surface to the polyethylene is tested for antibacterial or bacteriostatic properties by exposing the surface to E. coli. The surface is then analyzed for E. coli and found to have less colony forming units than a control. Another test is conducted by putting pasteurized milk in the formed bottle and observing the time necessary for the milk to spoil. Compared a polyethylene bottle without the material of example 1, the milk takes a longer time to spoil.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained.

Notwithstanding that the numerical ranges and parameters setting forth the broad scope of the technology are approximations, the numerical values set forth in the specific examples are reported as precisely as possible. Any numerical value, however, inherently contain certain errors necessarily resulting from the standard deviation found in their respective testing measurements.

It will be clear that the compositions and methods described herein are well adapted to attain the ends and advantages mentioned as well as those inherent therein. Those skilled in the art will recognize that the methods and systems within this specification may be implemented in many manners and as such are not to be limited by the foregoing exemplified embodiments and examples. In this regard, any number of the features of the different embodiments described herein may be combined into one single embodiment and alternate embodiments having fewer than or more than all of the features herein described are possible.

While various embodiments have been described for purposes of this disclosure, various changes and modifications may be made which are well within the scope contemplated by the present disclosure. Numerous other changes may be made which will readily suggest themselves to those skilled in the art and which are encompassed in the spirit of the disclosure.

What is claimed is:

1. A composition for removing biological contaminants comprising:
a support material comprising an organic polymer, cotton, glass fiber, or mixture thereof; and
a trivalent doped cerium oxide composition comprising a cerium oxide doped with a trivalent dopant selected from the group consisting of yttrium (Y), lanthanum (La), neodymium (Nd), praseodymium (Pr), and mixtures thereof,
wherein the trivalent doped cerium oxide composition is deposited on or within the support material.

2. The composition of claim 1, wherein the support material is an organic polymer selected from the group consisting of polyethylene, polyvinyl chloride, nylon, polypropylene, polyester, polyurethane, polyamide, polyolefin, polycarbonate, copolymers thereof, and mixtures thereof.

3. The composition of claim 1, wherein the composition is in a rigid or elastic form.

4. The composition of claim 1, wherein the dopant is La, Nd, or a mixture thereof.

5. The composition of claim 1, wherein the support material is cotton.

6. The composition of claim 2, wherein the organic polymer is polyethylene, polycarbonate, or a mixture thereof.

7. The composition of claim 1, wherein the composition comprises about 0.5 to about 80 weight % trivalent doped cerium oxide composition based on the total weight of the composition.

8. The composition of claim 7, wherein the composition comprises about 0.5 to about 50 weight % trivalent doped cerium oxide composition based on the total weight of the composition.

9. The composition of claim 1, wherein the biological contaminants are selected from the group consisting of bacteria, viruses, fungi, protozoa, and mixtures thereof.

10. The composition of claim 1, wherein the composition is a filter material or a plastic.

11. The composition of claim 1, wherein the composition removes approximately 90% or more of the biological contaminants.

12. A method for removing biological contaminants upon contact, comprising:
providing a composition comprising a support material comprising an organic polymer, cotton, glass fiber or mixture thereof and a trivalent doped cerium oxide composition comprising a cerium oxide doped with a trivalent dopant selected from the group consisting of yttrium (Y), lanthanum (La), neodymium (Nd), praseodymium (Pr), and mixtures thereof;
contacting the composition with a biological contaminant wherein the biological contaminant is selected from the group consisting of bacteria, viruses, mold, protozoa, fungi, and mixtures thereof; and
removing at least about 90% of the biological contaminant through contact with the composition.

13. The method of claim 12, wherein the composition is a filter material or a plastic.

14. The method of claim 12, wherein the composition removes approximately 99% or more of the biological contaminants.

15. The method of claim 12, wherein the biological contaminant is in an aqueous stream.

16. The method of claim 12, wherein the biological contaminant is in a gaseous stream.

17. The method of claim 12, wherein the contacting is through touch of a solid to the composition.

18. The method of claim 12 further comprising the steps of setting a target concentration of biological contaminant and monitoring after contacting for the biological contaminant.

19. The method of claim 12, wherein the biological contaminants are bacteria, viruses, or amoebae.

20. A method for treating a fluid comprising:
(i) providing a composition comprising a support material comprising an organic polymer, cotton, glass fiber, or mixture thereof and a trivalent doped cerium oxide composition comprising a cerium oxide doped with a trivalent dopant selected from the group consisting of yttrium (Y), lanthanum (La), neodymium (Nd), praseodymium (Pr), and mixtures thereof;
(ii) contacting a biological contaminant containing gaseous or aqueous stream with the composition, wherein the biological contaminant is selected from the group consisting of bacteria, viruses, fungi, protozoa, and mixtures thereof; and
(iii) removing biological contaminant from the gaseous or aqueous stream through contact with the composition.
